(19) United States
(12) Patent Application Publication
(10) Pub. No.: US 2002/0073362 A1
(43) Pub. Date: Jun. 13, 2002

(54) Remote evaluation of a data storage device

(76) Inventors: Badih Mohamad Naji Arnaout, Loveland, CO (US); Kenneth Wayne Probst, Longmont, CO (US); Walter Wong, Boulder, CO (US)

Correspondence Address: Jonathan E. Olson, Seagate Technology LLC, Intellectual Property Dept.-COL2LGL, 389 Disc Drive, Longmont, CO, 80503, US

(21) Appl. No.: 09/735,381

(22) Filed: Dec. 11, 2000

Related U.S. Application Data
(60) Provisional application No. 60/193,673, filed on Mar. 31, 2000.

(51) Int. Cl. G06F 11/26

(52) U.S. Cl. 714/42

(57) ABSTRACT

A data storage devices is evaluated remotely from a primary interface. The primary interface is configured to transmit device instructions through a medium longer than 50 kilometers. The test interface relays the instructions to the data storage device so that the test interface transmits back to the primary interface a sent response to the first device instruction. The test interface preferably distills data so that the sent response includes at most 1/10 of the bytes contained in the “raw” signal from the device, so that the test interface can reliably transmit the sent response through the medium.

In a preferred method, a device instruction from a primary interface is sent to the data storage device. The device then initiates a response to the instruction that is received at the primary interface. A performance characteristic value, preferably multi-valued, is derived based upon the sent response. With this method, evaluations can be performed without the necessity of moving the device under evaluation.

### RELATED APPLICATIONS

This application claims the benefit of U.S. Provisional Application No. 60/193,673 filed on Mar. 31, 2000.

### FIELD OF THE INVENTION

The invention relates to the field of data storage, and more particularly to the problem of evaluating data storage device performance remotely to facilitate improvements in device performance.

### BACKGROUND OF THE INVENTION

In recent years, data storage demands have grown exponentially, necessitating steady product development efforts on a large scale for disc and tape drives and similar electromechanical data storage systems. To take advantage of better performance and higher capacity offered by each generation of new products, there has been an increasing trend away from having small numbers of large data storage devices and toward having many small devices.

Another reason behind this trend is a growing desire in the industry to maintain at least partial system functionality even in the event of a failure in a particular system component. If one of the numerous mini/micro-computers fails, the others can continue to function. If one of the numerous data storage devices fails, the others can continue to provide data access. Also increases in data storage capacity can be economically provided in small increments as the need for increased capacity develops.

A common configuration includes a so-called “client/server computer” that is provided at a local network site and has one end coupled to a local area network (LAN) or a wide area network (WAN) and a second end coupled to a local bank of data storage devices (e.g., magnetic or optical, disk or tape drives). Local and remote users (clients) send requests over the network (LAN/WAN) to the client/server computer for read and/or write access to various data files contained in the local bank of storage devices. The client/server computer services each request on a time shared basis.

In addition to performing its client servicing tasks, the client/server computer also typically attends to mundane storage-management tasks such as keeping track of the amount of memory space that is used or free in each of its local storage devices, maintaining a local directory in each local storage device that allows quick access to the files stored in that local storage device, minimizing file fragmentation across various tracks of local disk drives in order to minimize seek time, monitoring the operational status of each local storage device, and taking corrective action, or at least activating an alarm, when a problem develops at its local network site.

Networked storage systems tend to grow like wild vines, spreading their tentacles from site to site as opportunities present themselves. After a while, a complex mesh develops, with all sorts of different configurations of client/server computers and local data storage banks evolving at each network site. The administration of such a complex mesh becomes a problem.

In the early years of network management, a human administrator was appointed for each site to oversee the local configuration of the on-site client/server computer or computers and of the on-site data storage devices.

In particular, the human administrator was responsible for developing directory view-and-search software for viewing the directory or catalog of each on-site data storage device and for assisting users in searches for data contained in on-site files.

The human administrator was also responsible for maintaining backup copies of each user's files and of system-shared files on a day-to-day basis. Also, as primary storage capacity filled up with old files, the human administrator was asked to review file utilization history and to migrate files that had not been accessed for some time (e.g., in the last 3 months) to secondary storage. Typically, this meant moving files that had not been accessed for some time, from a set of relatively-costly high-speed magnetic disk drives to a set of less-costly slower-speed disk drives or to even slower, but more cost-efficient sequential-access tape drives. Very old files that lay unused for very long time periods (e.g., more than a year) on a “mounted” tape (which tape is one that is currently installed in a tape drive) were transferred to unmounted tapes or floppy disks and these were held nearby for remounting only when actually needed.

When physical on-site space filled to capacity for demounted tapes and disks, the lesser-used ones of these were “archived” by moving them to more distant physical storage sites. The human administrator was responsible for keeping track of where in the migration path each file was located. Time to access the data of a particular file depended on how well organized the human administrator was in keeping track of the location of each file and how far down the chain from primary storage to archived storage, each file had moved.

The human administrator at each network site was also responsible for maintaining the physical infrastructure and integrity of the system. This task included: making sure power supplies were operating properly, equipment rooms were properly ventilated, cables were tightly connected, and so forth.

The human administrator was additionally responsible for local asset management. This task included: keeping track of the numbers and performance capabilities of each client/server computer and its corresponding set of data storage devices, keeping track of how full each data storage device was, adding more primary, secondary or backup/archive storage capacity to the local site as warranted by system needs, keeping track of problems developing in each device, and fixing or replacing problematic equipment before problems became too severe.

With time, many of the manual tasks performed by each on-site human administrator came to be replaced, one at a time on a task-specific basis, by on-site software programs. A first set of one or more, on-site software programs would take care of directory view-and-search problems for files stored in the local primary storage. A second, independent set of one or more, on-site software programs would take care of directory view-and-search problems for files stored in the local secondary or backup storage. Another set of one or more, on-site software programs would take care of making routine backup copies and/or routinely migrating older files down the local storage migration hierarchy (from primary storage down to archived storage). Yet another set of on-site software programs would assist in locating files that have been archived. Still another set of independent, on-site software programs would oversee the task of maintaining the physical infrastructure and integrity of the on-site system. And a further set of independent, on-site software programs would oversee the task of local asset management.

At the same time that manual tasks were being replaced with task-segregated software programs, another trend evolved in the industry where the burden of system administration was slowly shifted from a loose scattering of many local-site, human administrators—one for each site—to a more centralized form where one or a few human administrators oversee a large portion if not the entirety of the network from a remote site.

Despite these developments in the use of data storage devices, and the widespread use of basic monitoring systems, remote systems for the actual analysis of data storage devices do not exist. Data storage devices are generally used in locations that are remote from any expertise in improving their performance. There has accordingly been a long-felt need for systems that bring the devices and the expertise together. This need has thus far been addressed either by shipping the devices or having the experts travel, both approaches having significant drawbacks.

### SUMMARY OF THE INVENTION

Many disadvantages attributable to travel and shipping are avoided by evaluating data storage devices remotely from a primary interface. In a preferred apparatus, the primary interface is remotely coupled to a test interface via a transmission medium of 50 kilometers or longer, and the test interface is coupled directly to the data storage device. The primary interface is configured to transmit a first device instruction through the medium and the test interface to the data storage device so that the test interface transmits back to the primary interface a sent response to the first device instruction. The test interface preferably distills data so that the sent response includes at most 1/10 of the bytes contained in the “raw” signal from the device, so that the test interface can reliably transmit the sent response through the medium. Nonvolatile data storage devices incur a very low incremental cost for recording data relating to their performance on the device: optional mechanisms for taking advantage of this are described herein.

In a preferred method compatible with the apparatus, a device instruction from a primary interface is sent to the data storage device. The device then initiates a response to the instruction that is received at the primary interface. A performance characteristic value is derived based upon the sent response. With this method, substantial evaluation can be performed without the necessity of moving either the device or the expert directing the testing.

Additional features and benefits will become apparent upon a careful review of the following drawings and their accompanying detailed description.

### BRIEF DESCRIPTION OF THE DRAWINGS

FIG. 1 shows a primary interface constructed and arranged for configuring or evaluating data storage devices according to the present invention.

FIG. 2 shows a data storage device like those of FIG. 1 that is modified and/or evaluated by the present invention.

FIG. 3 shows a quality assurance or failure analysis method of the present invention.

FIG. 4 shows a more basic embodiment of the present invention using some of the hardware components of FIG. 1.

FIG. 5 depicts another method of the present invention.

FIG. 6 shows a preferred method of performing remote analysis compatible with that of FIG. 5.

FIG. 7 shows another preferred method of performing remote analysis.

FIG. 8 shows yet another method of performing remote analysis.

FIG. 9 shows a display such as may appear at a primary or secondary interface in accordance with the present invention.

### DETAILED DESCRIPTION

Numerous aspects of configuring and testing data storage devices that are not a part of the present invention, or are well known in the art, are omitted for brevity. These include specifics of device command syntax, specific control of device parametric tests and their implementations, and physical analysis of device failure mechanisms. Although each of the many examples below shows more than enough detail to allow those skilled in the art to practice the present invention, subject matter regarded as the invention is broader than any single example below. The scope of the present invention is distinctly defined, however, in the claims at the end of this document.

Definitions of certain terms are provided in conjunction with the figures, all consistent with common usage in the art but some described with greater specificity. For example, a “raw” response signal is one that originates in a device under evaluation, typically weak but highly accurate. A “sent” response is one that is adapted or otherwise carried as necessary for transmission across a very substantial medium. A sent response is often more “robust” than the raw signal from which it is derived, meaning that it is more likely to reach its destination without a loss of any critical information.

Except as noted, also, all quantitative and qualitative descriptors employ their broadest meaning consistent with industry usage. For example, a “medium” is used herein to include a composite medium including two or more distinct transmission media (e.g. fiberoptic cable and air) operatively coupled in series through a suitable transmitter. An “interface” is an apparatus at a boundary of a computer system that conveys electronic information, such as a screen display, modem, or antenna.

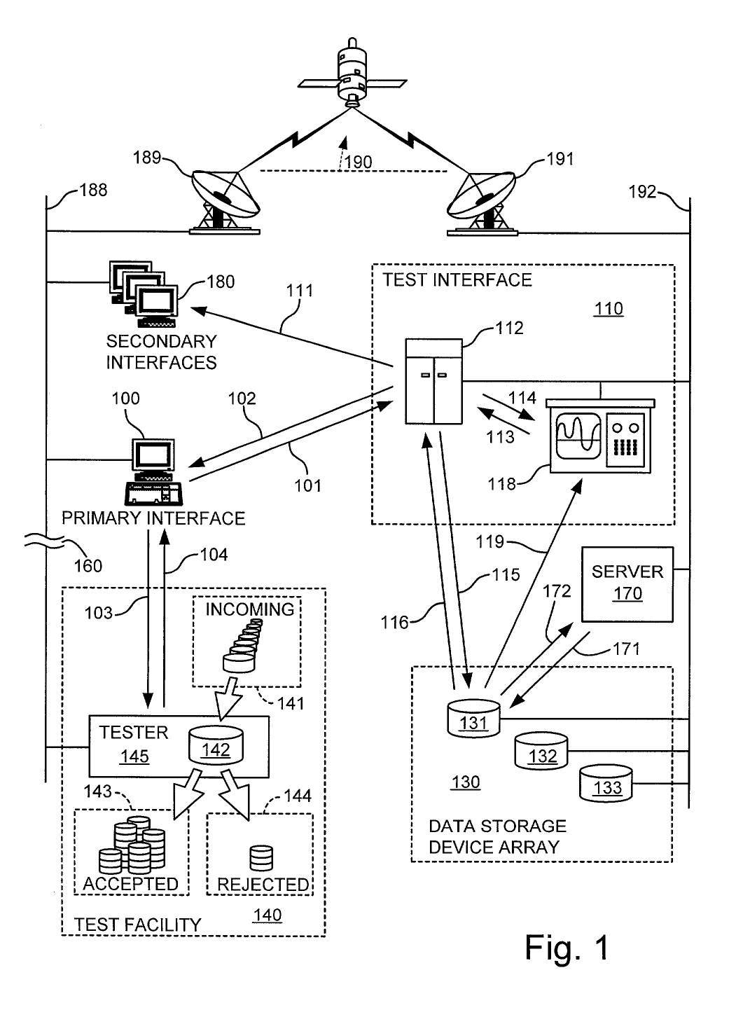

Turning now to FIG. 1, there is shown a primary interface 100 constructed and arranged for configuring or evaluating data storage devices 131, 142 according to the present invention. In one mode of operation, primary interface 100 sends procedure calls including sets of device instructions, test interface interrupts, and similar signals 101 to host computer 112 of test interface 110. After receiving one or more procedure calls 101, host computer 112 relays a signal 115 to data storage device 131 that includes a device instruction at least partially contained within procedure call 101.

It should be understood that procedure calls 101, host signals 115, and similar signals depicted schematically by arrows in FIG. 1 are actually carried across a network comprising two buses 188, 192. The buses 188, 192 are coupled through a first transmitter/receiver 189, a very substantial transmission medium 190, and a second transmitter/receiver 191. It is an important feature of the present invention that the media or medium 190 is at least 50-100 kilometers long along the path of signal travel so that the primary and test interfaces can have a similar separation that is inconvenient to traverse. Bus 188 is shown with a break 160 to indicate that another very substantial transmission medium (i.e. lines of bus 188) links the primary interface with a tester 145 in a test facility 140.

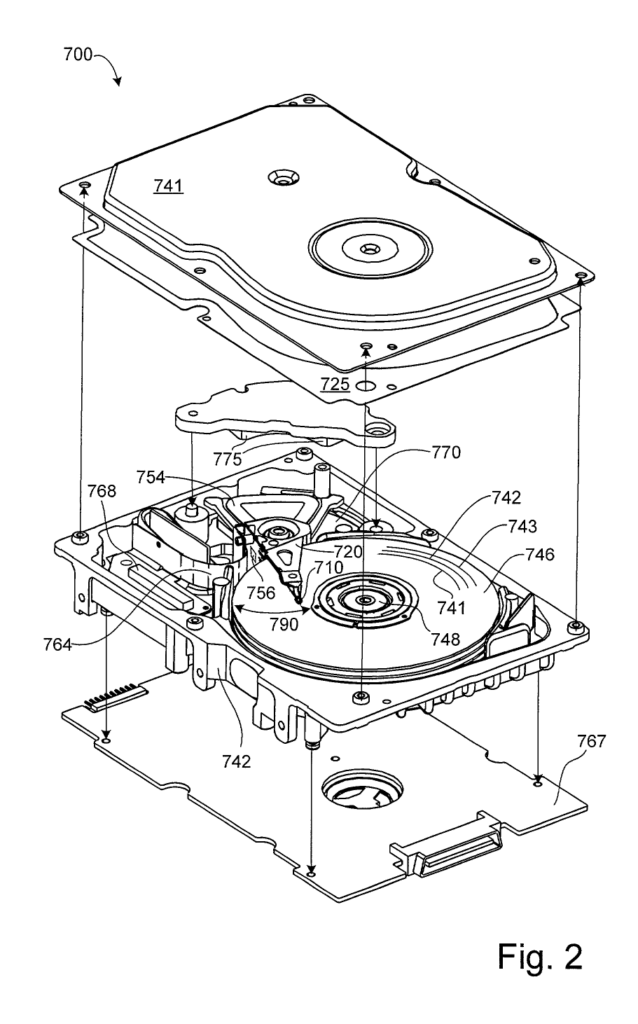

Bus 192 also connects to server 170 which controls data storage and retrieval signals 171, 172 flowing to and from data storage devices 131, 132, 133 of storage device array 130 during normal operation. Test interface 110 also includes a digital oscilloscope 118 coupled to monitor signals 119 received from a probe coupled to a test terminal (not shown) of device 131. For example, the oscilloscope can desirably monitor an amplified readback signal received at an output line of preamp 756 and reflecting fields sensed by a head 710 (See FIG. 2). In response to a nonperiodic triggered event such as may occur when a readback signal reflects contact with an asperity, scope output signal 113 can simply include a pulse to indicate an occurrence of the event. Scope output signal 113 can also include digital image data to show the shape of a signal as a function of time in the vicinity of the triggered event. Either way, host computer 112 can provide scope control signals 114 to oscilloscope 118 to effect triggering criteria, scale control, and similar scope control data contained within procedure calls 101 from primary interface 100.

Data storage devices 131, 142 may contain sophisticated channel circuitry and firmware for detecting and correcting errors, for servo control, and for self-diagnostics. As such, a great quantity and variety of meaningful information can be provided by a raw response signal 116 uploaded directly to host computer 112. It should be emphasized, however, that transmission medium 190 will typically be bandwidth-limited, at least intermittently. It is therefore especially useful, in data storage device evaluation, for host computer 112 to distill the bytes of digital data derived from a raw response signal 116 and stored. The distilled data sent as a response signal 102 back to the primary interface 100 is desirably at most about 10% of the digital data so derived and stored. Similarly it is desirable for host computer 112 to distill from scope output signal 113 images at a rate of at most 1-2 images per second, although the scope output signal 113 sends images many times faster. By distilling data as described above, the test interface can reliably transmit sent response signal 102 through medium 190 to primary interface 100. In a preferred embodiment, similarly distilled sent response signals 111 are also provided to one or more secondary interfaces 180 that are also remote from test interface 110. This permits several experts in various locations to receive performance characteristic values and to confer telephonically with an operator at primary interface 100.

Test interface 110 permits remote control and evaluation of data storage device 131 in a “field application” such as a customer site. Note that tester 145 can similarly function as a test interface so that primary interface 100 can control and monitor the operation of a device 142 in a manufacturing or test facility 140. When the percentage of incoming devices 141 that are becoming accepted drives 143 drops sharply, it is often possible for an expert to reconfigure tester 145 so that the rejected devices 144 are less often “good” devices that have been mis-configured or mis-tested. With the present invention, a remote expert at primary interface 100 can provide signals 103 to tester 145 to reconfigure a device 142 under test, to retest it, and to receive the results (via response signal 104).

FIG. 2 shows a data storage device 700 like device 131 of FIG. 1, modified or evaluated by means of the present invention. Device 700 includes base 742 and top cover 741, which both engage gasket 725 to form a sealed housing that maintains the clean environment inside the device 700. One or more discs 746 are mounted for rotation on spindle motor hub 748. Each disc 746 has two horizontal data surfaces. Several transducers 710 are mounted onto respective arms of actuator assembly 720. As depicted, transducers 710 can be positioned over any of many thousand annular data tracks 741, 742, 743 of discs 746 to read and write data on each. The actuator assembly 720 is adapted for pivotal motion under control of a voice coil motor (VCM) comprising voice coil 754 and voice coil magnets 770, 775 to controllably move transducers 710 each to a respective desired track 748 along an arcuate path 790. As the discs 746 rotate, transducers 710 transmit electrical signals related to the strength of the magnetic field adjacent each moving surface of each disc 746. Preamplifier 756 amplifies the signals, which carry positional and user data, so that they can pass via a flex circuit 764 and a connector 768 to electronic circuitry on the controller board 767.

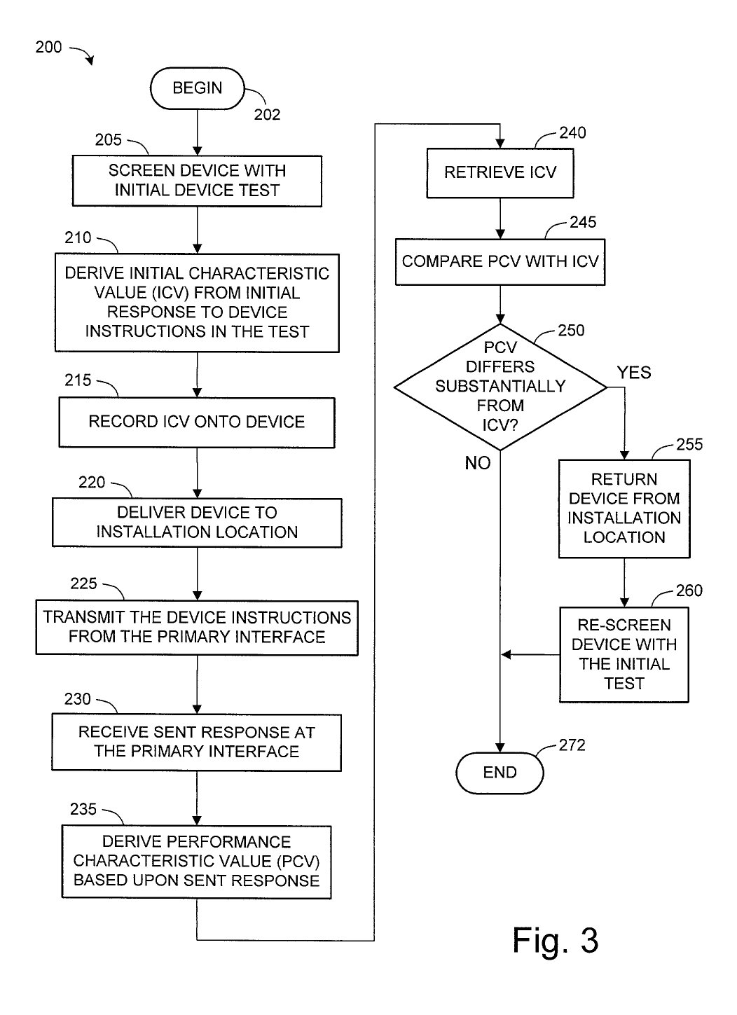

FIG. 3 shows a quality assurance or failure analysis method 200 of the present invention comprising steps 202 through 272. An electromechanical device (such as data storage devices 131, 700 described above) is first tested with an initial device test 205. In a disc drive, the test desirably includes device instructions such as commands to perform these head parametric measurements: Pulse Width 50 (the pulse width of an isolated write pulse at the 50% level), Track Average Amplitude (the average amplitude of the raw read data written at a chosen frequency), OverWrite (the low residual signal left over after a high frequency signal is written over a low frequency signal), Resolution (the ratio of the track average amplitude for a high and low frequency waveform), Amplitude Asymmetry (calculated as |(taa+−taa−)|/(taa+taa−) ), and Lower Base Separation (LBSep, the measurement of the floor noise of the signal), and read seek time between tracks 741, 742 to name a few.

Any of these or other measurable parameters define an initial characteristic value (ICV) that can be derived 210 from the initial response from the device 142 to the device instructions. One or more ICV's are recorded onto the (recording surfaces of) the device 215 before the device is delivered 220. To verify environmental conditions, or the absence of shipping damage, or in response to an error message indicating a device problem, a remote evaluation begins.

First, at least one of the device instructions used in the initial steps 205, 210 are transmitted from the primary interface 225 (through the medium and the test interface to the device). The test interface then provides a sent response to the primary interface indicative of the device's response 230, from which the primary interface derives a performance characteristic value (PCV) 235. Preferably, most or all of the calculations and/or selections making up this derivation are performed at the test interface so as to cause at most 10-50% of the digital data used in the test interface to be sent through the (bandwidth-limited) medium. The ICV is also retrieved from the device 240 and compared with the PCV 245. Optionally the primary interface may direct that this comparison be performed at the test interface, and that the results of the comparison be conveyed to the primary interface as a boolean PCV.

If the multi-valued (non-boolean) PCV differs substantially from the ICV 250, then the device is returned from the installation location 255 so that it can be re-screened with the initial test 260. This method 200 permits such returns to occur only in circumstances where a substantial change in device performance appears to have occurred, if the device is not generally returned absent such a change. This method 200 will also reveal performance changes resulting from mechanical shocks that occur during shipment to the installation site when such changes affect a remotely measurable PCV (and to which the error is therefore attributable). This method 200 will also reveal transitory effects such as may occur from altitude changes between the initial test site and the installation. Without testing at the installation site, such effects will not ordinarily be verifiable. Altitude changes can change the behavior of some electromechanical systems such as disc drives, in which a transducer 710 is part of a slider supported by an air bearing. Other environmental factors that may affect performance of a device in a field application (such as device array 130 of FIG. 1) are temperature, power supply characteristics, electromagnetic noise, and mechanical disturbances.

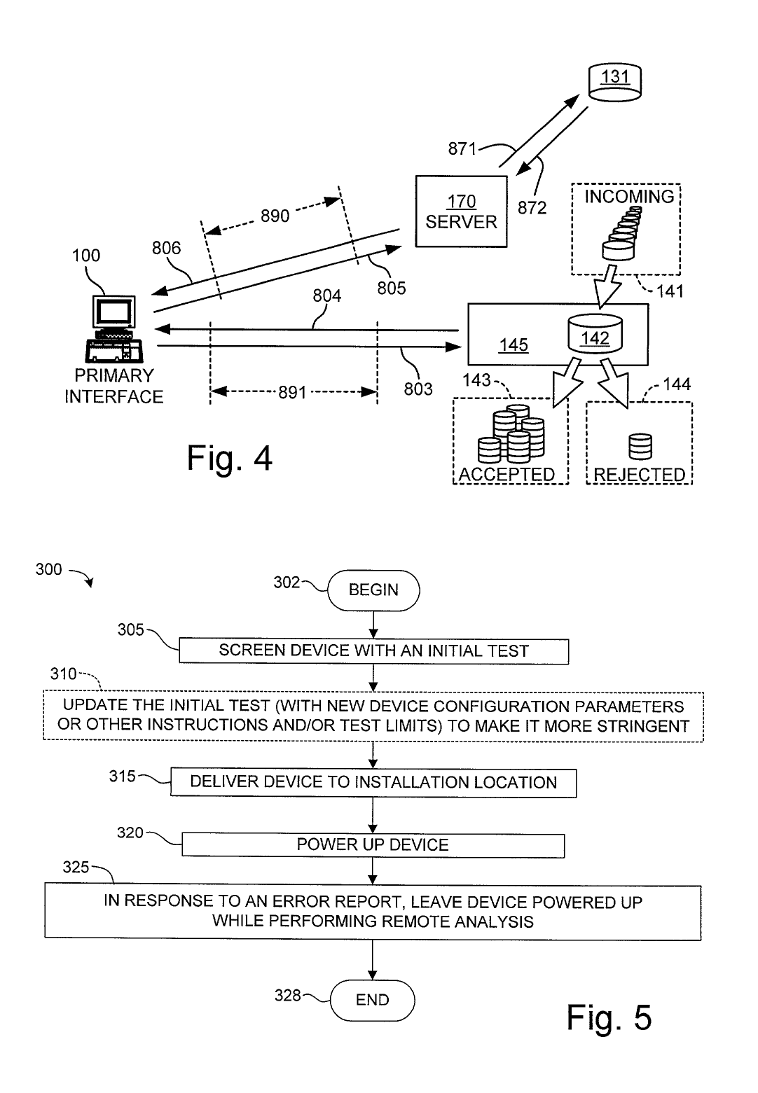

FIG. 4 shows a more basic embodiment of the present invention using some of the hardware components of FIG. 1 with different operative elements implemented in software. Primary interface 100 is operatively coupled to server 170 remotely, as before. Apart from data storage and retrieval, however, server 170 is here configured as a test interface through which primary interface 100 transmits device commands to device 131. Suppose, for example, that a resonance in device 131 shifts to an under-compensated frequency in response to a temperature increase of 10° C. In normal operation, server 170 senses a discrepant behavior such as an error message from the device or unusually slow response times. An expert can respond to this circumstance quickly, without travel, from primary interface 100. After having diagnosed the problem via procedure calls 805 that implement diagnostics, the expert derives a minimum amount of compensation required by using a performance characteristic value received or otherwise derived from a sent response signal 806 responsive to the diagnostics. The expert then updates the servo control firmware to increase the compensation at the under-compensated frequency by a slightly larger amount. Next, the expert transmits additional procedure calls 805 that include the updated firmware so that the server 170 transmits commands and data 871 to implement the firmware to device 131. The device returns a raw response signal 872 indicating that the firmware is implemented, which the server 170 relays in the sent response signal 806 to the expert at the primary interface. Next, the primary interface instructs the device to perform diagnostics to ensure that the update worked and did not create any detectable problems. Finally, the server 170 returns to normal operation, exchanging data storage and retrieval data in signals 871, 872 with device 131. Note that all of this was accomplished without the benefit of a dedicated test interface 110, and that it was accomplished remotely through a transmission medium longer than 50 km, and typically in less than a day.

This approach facilitates gathering feedback information from field failures, also, which is typically how several kinds of failures are discovered. For a product still being manufactured, the firmware and other code updates can also be forwarded to a manufacturing facility so that similar resonances and other failure mechanisms can be prevented. Along these lines, in the present scenario, primary interface 100 sends similar procedure calls 803 to tester 145 so that the updated firmware is installed onto each device under test 142. Tester 145 responds with a sent response signal 804 acknowledging the change and providing yield data for incoming devices 141 as they become accepted 143 or rejected 144.

FIG. 5 depicts another method 300 of the present invention, comprising steps 302 through 328. The method 300 is optionally performed by a primary interface 100 configuration like that described above with reference to either FIG. 1 or FIG. 4. After data storage device is screened with an initial test 305, the test is updated to make it more stringent 310. This optional step of updating 310 is advantageous in conjunction with the method of FIG. 5. A test is “more stringent,” as used herein, if it might consistently fail any device which the compared “less stringent” test would consistently pass, assuming a stable and calibrated tester. A screen containing a requirement that a given PCV be at least 10 mV is thus made more stringent by requiring that the PCV be at least 11 mV, even if the new screen is simultaneously made less stringent with respect to several others of its requirements.

Also after the screening step 305, the device is delivered to an installation location 315, installed, and eventually powered up 320. The present method involves a step of leaving the device powered up continuously from when an error is reported until remote analysis is conducted 325. This step of leaving while performing 325 has the unexpected benefit of permitting some errors to be characterized that will not otherwise be repeatable. This is because powering down a device, bringing anything into contact with the device or its housing, or waiting too long after an error often removes the circumstance that caused the error. In a preferred embodiment, a primary interface 100 causes a test interface (such as server 170 of FIG. 4) to interrupt normal operations and initiate a device diagnostic sequence in response to a predefined set of error reports, subsequently reporting the result back to the primary interface.

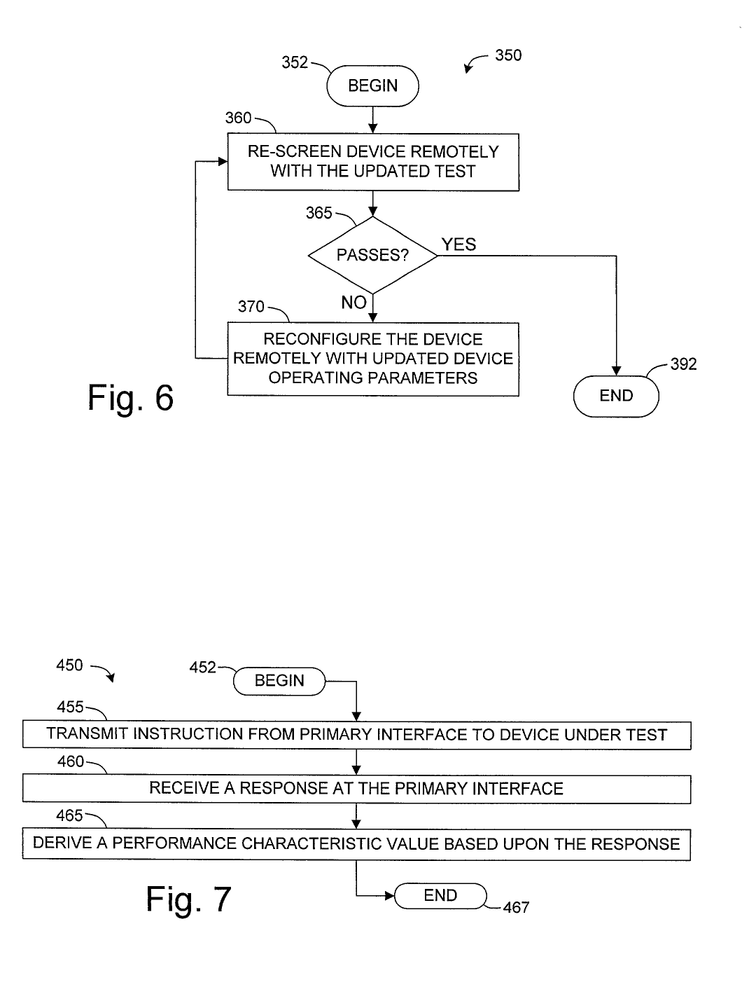

FIG. 6 shows a preferred method 350 of performing remote analysis comprising acts 352 through 392, and suitable for the leaving while performing step 325 of FIG. 5. The device is re-screened remotely with the updated test 360. If it fails the re-screening 365, the device is reconfigured remotely by updating device operating parameters or firmware 370. As shown, attempts to reconfigure the device to improve enough to pass a more stringent screen can be repeated a few times so as to improve yields for the device in situ. Methods such as that of FIG. 6 can be used to avoid a recall of devices with a known problem correctable by software.

FIG. 7 shows another preferred method 450 of performing remote analysis comprising steps 452 through 467. Instructions are transmitted from a primary interface to a device under test 455. A response originating at the device is received at the primary interface 460. A performance characteristic value is derived based on the response 465. This method 450 is suitable for the rescreening or reconfiguring steps 360, 370 of FIG. 6. In the latter case, the PCV may simply be a boolean indication that the reconfiguration was successful.

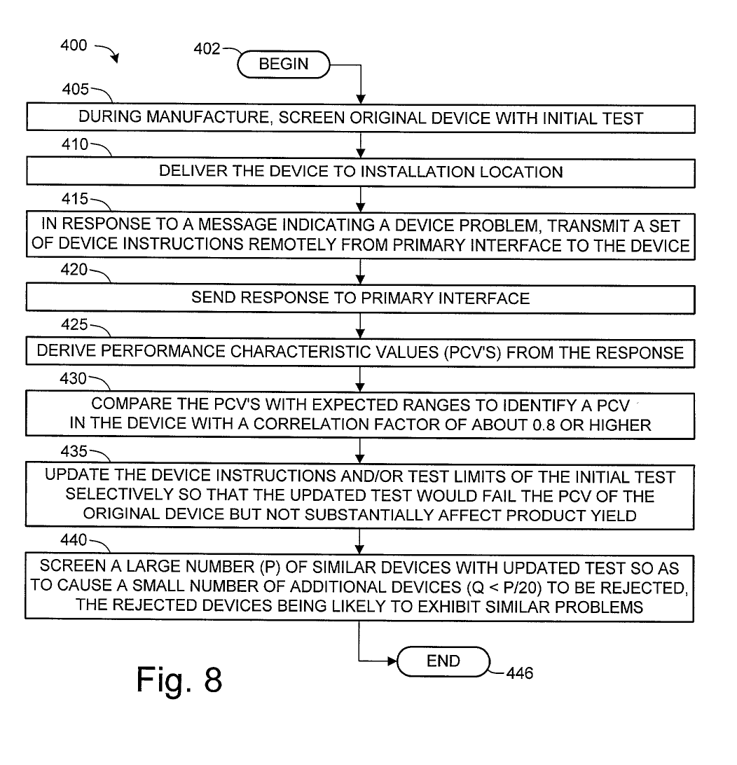

FIG. 8 shows yet another method 400 of performing remote analysis comprising steps 402 through 446. An “original” device is screened 405 and delivered 410. In response to a problem indication, a primary interface sends a set of device instructions 415 and receives a response 420 from which it derives one or more PCV's 425. The PCV's are compared with expected ranges to determine which PCV's, if any, correlate with the device problem indication 430. Assuming such a PCV is found, the device instructions and/or test limits of the test are updated selectively 435 so as to reduce product yield by less than 2-5%. Finally, a large number of similar devices are screened with the updated test 440.

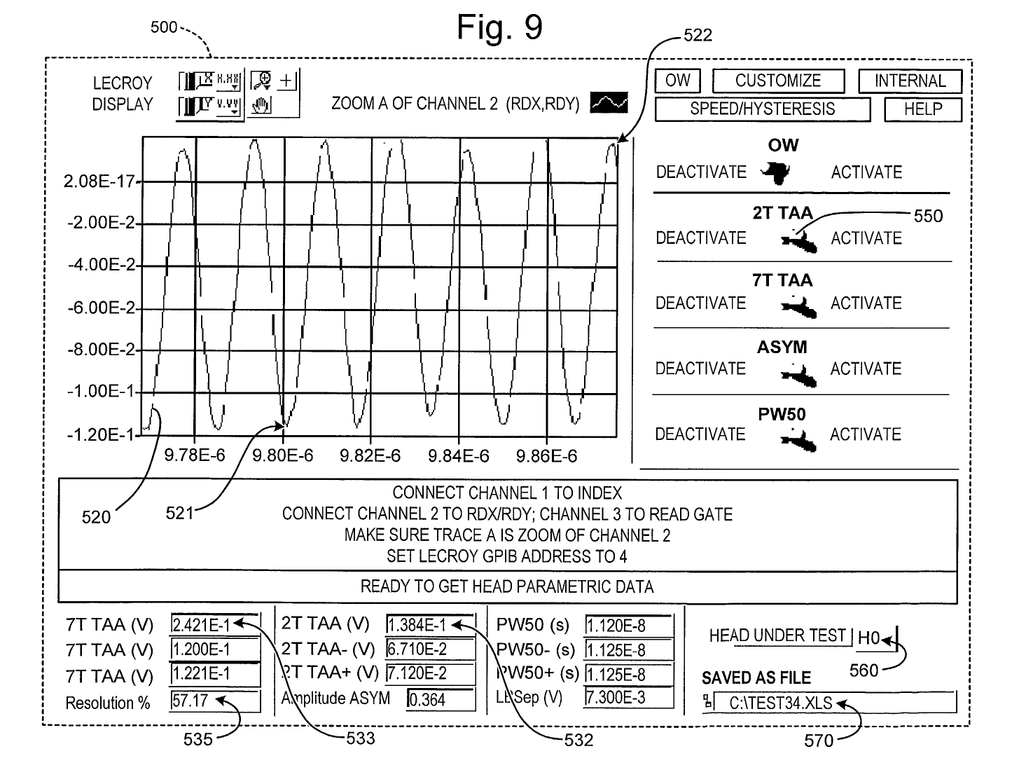

FIG. 9 shows a display 500 such as may appear at a primary or secondary interface in accordance with the present invention. Display 500 includes a pixel image 510 reflecting the shape of an amplified readback signal 520 as a function of time derived from a magnetic field such as may be sensed by a transducer 710 in a disc drive 700. In an alternate embodiment, the test interface is configured to perform frequency transforms so that the sent response includes frequency-domain data indicative of device performance. In accordance with the present embodiment, a minimum 521 and a maximum 522 are examples of PCV's that may be estimated based on the sent response (which contained the image 510 in the form of a digital signal). In the present case, the user generates procedure calls to be sent to the test interface by controls such as toggle switch 550, which is shown as a horizontal toggle with a shadow (in an activated position). This position of toggle switch 550 causes a “run head parametrics” button control to initiate a sequence in which a “2T TAA” test is included. After the test, the display 500 is updated to show PCV's 532, 533 calculated at the test interface by conventional methods. The “Resolution %” PCV 535 is estimated at the primary or test interface based on these PCV's. (This estimate is generally derived as an arithmetic combination, and in the example shown, as a quotient of the “2T TAA” PCV 532 and the “7T TAA” PCV 533.) Note that the display 500 also includes an indicator 560 of which subsystem of the device is being tested (e.g. H0, head number zero) and an indicator 570 of a file local to the primary interface system within which the PCV's are stored for further compilation, comparison and other analysis.

Alternately characterized, referring again to FIG. 1, a first contemplated embodiment of the present invention is an apparatus for evaluating a data storage device 131, 142, 700 remotely via a test interface 110, 145, 170. The apparatus includes a primary interface 100 configured to be remotely coupled to the test interface 110, 145, 170 via a transmission medium longer than 50 kilometers 190, 890, 891 (along the transmission path). The primary interface 100 is also configured to transmit a device instruction (i.e. signal 803, 805) through the medium and the test interface 110, 145, 170 to the data storage device 131, 142 so that the test interface 110, 145, 170 transmits back to the primary interface 100 a sent response (i.e. signal 804, 806, 871) to the device instruction.

Referring again to FIGS. 2, 4 & 8, a second contemplated embodiment is a method of evaluating a data storage device 131, 142, 700 that begins with screening it with an initial test 405. The device is delivered to an installation location 410 and installed. In response to an indication of discrepant behavior on the part of the device 131, 142, 700, the primary interface 100 sends a device instruction to the device 415 and receives a response 420. A performance characteristic value is stored in a register, having been derived from the sent response 425 (e.g. converted from a digital signal to a stored bit pattern, with or without calculations interposed). After a discrepant behavior such as an error report (from step 415) is sensed, updating the initial test so as to include a second device instruction and so that the updated test will generally pass other devices, but will fail when another device like the delivered device is encountered 430, 435. Additional devices are then screened with the updated test 440.

All of the structures described above will be understood to one of ordinary skill in the art, and would enable the practice of the present invention without undue experimentation. It is to be understood that even though numerous characteristics and advantages of various embodiments of the present invention have been set forth in the foregoing description, together with details of the structure and function of various embodiments of the invention, this disclosure is illustrative only. Changes may be made in the details, especially in matters of structure and arrangement of parts within the principles of the present invention to the full extent indicated by the broad general meaning of the terms in which the appended claims are expressed. For example, the particular elements may vary depending on the particular application for the present system while maintaining substantially the same functionality, without departing from the scope and spirit of the present invention. In addition, although the preferred embodiments described herein are largely directed to disc drives, it will be appreciated by those skilled in the art that the teachings of the present invention can be applied to other data handling devices and the like without departing from the scope and spirit of the present invention.

What is claimed is:

1. An apparatus for evaluating a data storage device remotely via a test interface coupled thereto, comprising:
a primary interface configured to be remotely coupled to the test interface via a transmission medium longer than 50 kilometers, the primary interface also configured to transmit a first device instruction through the medium and the test interface to the data storage device so that the test interface transmits back to the primary interface a sent response to the first device instruction.

2. The apparatus of claim 1, further comprising the test interface, the test interface containing a large number N of result bytes derived from a raw signal from the device, in which the test interface extracts less than N/10 bytes as the sent response so that the test interface can reliably transmit the sent response through the medium to the primary interface.

3. The apparatus of claim 1, further comprising the test interface, which comprises:
an oscilloscope operatively coupled to the data storage device; and
a server operatively coupled to the data storage device, to the oscilloscope, and to a network comprising the medium, the server configured to receive image data from the oscilloscope and to transmit a portion thereof to the primary interface.

4. A method of using the apparatus of claim 1 comprising acts of:
(a) screening the data storage device with an initial test, the initial test including the first device instruction;
(b) recording an initial characteristic value derived from an initial response to the first device instruction;
(c) delivering the data storage device to an installation location;
(d) after the delivering act (c), transmitting the first device instruction from the primary interface to the data storage device;
(e) receiving at the primary interface the sent response to the first device instruction;
(f) deriving the performance characteristic value based upon the sent response; and
(g) generating an indication of whether the performance characteristic value differs substantially from the initial characteristic value.

5. The method of claim 4, further comprising acts of:
(h) returning the data storage device from the installation location; and
(i) re-screening the data storage device with the initial test if the indication is positive and otherwise generally not re-screening the data storage device with the initial test.

6. A method of using the apparatus of claim 1 comprising acts of:
(a) screening the data storage device with an initial test;
(b) updating the initial test so as to include the first device instruction and so that the updated test is more stringent than the initial test;
(c) delivering the data storage device to an installation location;
(d) after the delivering act (c), transmitting the first device instruction from the primary interface to the data storage device;
(e) receiving at the primary interface the sent response to the first device instruction;
(f) deriving the performance characteristic value based upon the sent response; and
(g) re-screening the data storage device with the updated test by comparing the performance characteristic value with an expectation while the device still remains at the installation location.

7. A method of using the apparatus of claim 1 comprising acts of:
(a) screening the data storage device with an initial test;
(b) updating the initial test so as to include the first device instruction and so that the updated test is more stringent than the initial test;
(c) delivering the data storage device to an installation location;
(d) after the delivering act (c), transmitting the first device instruction from the primary interface to the data storage device;
(e) receiving at the primary interface the sent response to the first device instruction;
(f) deriving the performance characteristic value based upon the sent response; and
(g) re-screening the data storage device with the updated test by comparing the performance characteristic value with an expectation while the device still remains in situ.

8. A method of using the apparatus of claim 1 comprising acts of:
(a) screening the data storage device with an initial test;
(b) updating the initial test so as to include the first device instruction and so that the updated test is more stringent than the initial test;
(c) delivering the data storage device to an installation location;
(d) powering up the data storage device;
(e) after the powering up act (d), transmitting the first device instruction from the primary interface to the data storage device;
(f) receiving at the primary interface the sent response to the first device instruction;
(g) deriving the performance characteristic value based upon the sent response; and
(h) re-screening the data storage device with the updated test by comparing the performance characteristic value with an expectation while the device still remains powered up.

9. A method of using the apparatus of claim 1 comprising acts of:
(a) screening the data storage device with an initial test;
(b) delivering the data storage device to an installation location;
(c) after the delivering act (b), transmitting the first device instruction remotely from the primary interface to the data storage device;
(d) receiving at the primary interface the sent response to the device instruction;
(e) deriving the performance characteristic based upon the sent response;
(f) sensing a discrepant behavior in the data storage device;
(g) updating the initial test so as to include a second device instruction and so that the updated test will fail when the performance characteristic value is encountered and otherwise generally pass;
(h) screening many additional data storage devices with the updated test so as to cause a small number of the additional devices to be rejected, the small number of additional devices being at risk of exhibiting the discrepant behavior.

10. A method of using the apparatus of claim 1 comprising acts of:
(a) transmitting the first device instruction from the primary interface to the data storage device;
(b) receiving at the primary interface the sent response to the first device instruction; and
(c) deriving the performance characteristic value based upon the sent response.

11. A method of evaluating a data storage device comprising acts of:
(a) transmitting a first device instruction from a primary interface to the data storage device;
(b) receiving at the primary interface a sent response to the first device instruction; and
(c) deriving a performance characteristic value based upon the sent response.

12. An apparatus for evaluating a data storage device comprising:
a primary interface remote from the data storage device; and
means for transmitting a device instruction to the data storage device and for transmitting back to the primary interface a response to the device instruction.
